(19) United States
(12) Patent Application Publication
(10) Pub. No.: US 2025/0171375 A1
(43) Pub. Date: May 29, 2025

(54) METHOD FOR PREPARING BORON-MAGNESIUM-CONTAINING COMPOUND FERTILIZER

(71) Applicant: Liaoning Tianhe Agricultural Technology Co., Ltd, Anshan City (CN)

(72) Inventors: Dawei JIANG, Anshan City (CN); Li ZHANG, Anshan City (CN); Jingheng XIA, Anshan City (CN); Zitao JIA, Anshan City (CN); Qinglei XIA, Anshan City (CN); Yue GAO, Anshan City (CN); Dong XIA, Anshan City (CN); Zhongming LUAN, Anshan City (CN); Mingzhu HAN, Anshan City (CN)

(73) Assignee: Liaoning Tianhe Agricultural Technology Co., Ltd, Anshan City, Liaoning (CN)

(21) Appl. No.: 18/592,736

(22) Filed: Mar. 1, 2024

(30) Foreign Application Priority Data
Nov. 28, 2023 (CN) 202311611355X

(51) Int. Cl. C05C 3/00; C05G 5/12

(52) U.S. Cl. CPC C05C 3/00; C05G 5/12

(57) ABSTRACT

Provided is a method for producing a boron-magnesium-containing compound fertilizer. In the disclosure, a boron mud is dissolved in an ammonium sulfate solution to obtain a boron-magnesium-containing solution and ammonia gas; the boron-magnesium-containing solution is crystallized by baking to remove water to obtain a boron-magnesium-containing powder; and the ammonia gas is absorbed with sulfuric acid to obtain an ammonium bisulfate absorption solution; the boron-magnesium-containing powder, the ammonium bisulfate absorption solution, and a first raw material are mixed to obtain a boron-magnesium-containing acid-ammonia slurry; and the boron-magnesium-containing acid-ammonia slurry, a second raw material, and a binder are subjected to granulation to obtain the boron-magnesium-containing compound fertilizer.

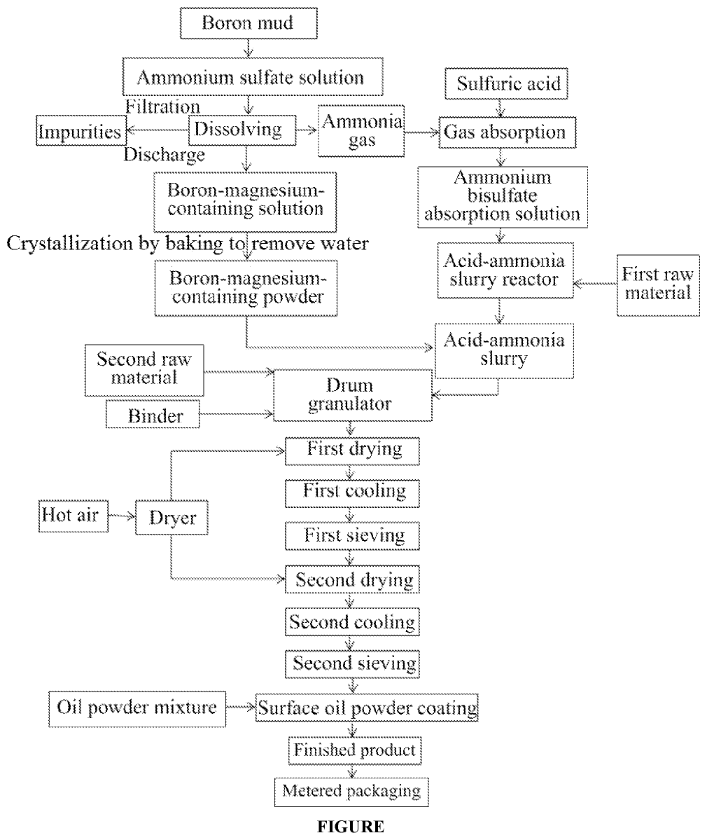

### CROSS REFERENCE TO RELATED APPLICATION

This patent application claims the benefit and priority of Chinese Patent Application No. 202311611355X filed with the China National Intellectual Property Administration on Nov. 28, 2023, the disclosure of which is incorporated by reference herein in its entirety as part of the present application.

### TECHNICAL FIELD

The present disclosure relates to the technical field of compound fertilizers, and in particular to a method for producing a boron-magnesium-containing compound fertilizer.

### BACKGROUND

Boron is an important chemical non-metallic mineral resource and an important inorganic chemical raw material in the fields such as new energy, metallurgy, aerospace, and national defense. Boron is also known as “industrial monosodium glutamate”, and mining and production thereof are of strategic significance. With the development of emerging industries such as new materials, new energy, and new information technology, the mining of boron ores in China has increased in recent years. The main producing area of boron in Liaoning Province is located in Kuandian Manchu Autonomous County, Dandong City, while boron minerals are mainly boromagnesite ores. When mining the boromagnesite ores and processing the same into primary products of borax and boric acid, a large amount of muddy products are produced. These muddy products have low boron and magnesium contents and a complex composition, and require a relatively high cost in chemical processing or purification. This makes the muddy products difficult to be re-produced and reused, thus being defined as an industrial waste, boron mud. The boron mud mainly includes MgO, B₂O₃, SiO₂, Fe₂O₃, Al₂O₃, and CaO. Among them, the trace element boron and the medium element magnesium are relatively rare and precious, especially playing an extremely important role in crop growth.

In 1923, K. Warington discovered that boron is an essential element for plants. In terms of growth, boron can promote the transportation and metabolism of carbohydrates in crops, and can also improve the supply of organic nutrients to various organs of the crop, thus promoting the elongation and division of crop cells. In terms of fruiting, boron can promote the fertilization of crops, stimulate the pollen germination of crops and the elongation of pollen tubes, such that the crops can be pollinated successfully, thereby improving the pollination rate, seed setting rate, and fruit setting rate of crops. In terms of auxiliary absorption, boron can improve a nitrogen-fixing ability of rhizobia in leguminous crops and promote the absorption of calcium by crops. Boron has a content in crops generally ranging from 2/10,000-3/10,000 to 1/100 by dry weight, and is a trace element required by typical crops.

Magnesium is a core metal element in the chlorophyll molecule group and a component of phytohormones. Magnesium can promote the synthesis of proteins from amino acids and participates in all phosphate conversion processes in the synthesis and conversion of nutrients. Therefore, there is no photosynthesis without magnesium, and a lack of magnesium may reduce crop yields. On the contrary, an increased magnesium content can promote the crop yields. Magnesium ions can activate a variety of enzymes, promote the conversion and metabolism of saccharides in crops, promote the synthesis of fat and protein in crops, and promote the formation of vitamin A and vitamin C in crops. Magnesium can also prevent the invasion of pathogens and improve the disease prevention and resistance of crops. The content of magnesium in plant tissues and organs varies depending on the type and variety of crops, and is generally 0.05% to 0.70%. In summary, magnesium is an essential medium element for crops.

It can be seen from the impact of boron and magnesium on crops that using boron and magnesium in the boron mud as raw materials to produce and process compound fertilizers is of great significance to the utilization of waste residue and the promotion of crop growth. However, there is currently a poor degree of resource utilization of boron mud in this field, and the boron mud is generally treated as an industrial waste, resulting in a large amount of waste of resources.

### SUMMARY

In view of this, the present disclosure provides a method for producing a boron-magnesium-containing compound fertilizer. In the present disclosure, the boron-magnesium-containing compound fertilizer is prepared by using a boron mud as a raw material, which can realize the resource utilization of the industrial waste boron mud. Moreover, the method shows a high production efficiency and an environmental-friendly process.

To achieve the above object, the present disclosure provides the following technical solutions:

The present disclosure provides a method for producing a boron-magnesium-containing compound fertilizer, including the following steps:
dissolving a boron mud in an ammonium sulfate solution to obtain a boron-magnesium-containing solution and ammonia gas; crystallizing the boron-magnesium-containing solution by baking to remove water to obtain a boron-magnesium-containing powder; and absorbing the ammonia gas with sulfuric acid to obtain an ammonium bisulfate absorption solution;
mixing the boron-magnesium-containing powder, the ammonium bisulfate absorption solution, and a first raw material to obtain a boron-magnesium-containing acid-ammonia slurry, where the first raw material includes monoammonium phosphate and/or diammonium phosphate; and
subjecting the boron-magnesium-containing acid-ammonia slurry, a second raw material, and a binder to granulation to obtain the boron-magnesium-containing compound fertilizer, where the second raw material includes one or more selected from the group consisting of a phosphate fertilizer, a nitrogen fertilizer, and a potassium fertilizer.

In some embodiments, the method further includes after the dissolving, filtering an dissolved solution obtained from the dissolving to obtain a solid as an impurity and a filtrate as the boron-magnesium-containing solution.

In some embodiments, the boron-magnesium-containing powder contains magnesium with a mass fraction of 7.8% to 8.2% and boron with a mass fraction of 0.9% to 1.0%.

In some embodiments, the sulfuric acid has a concentration of 50 wt %; and the absorbing is conducted with an acid mist.

In some embodiments, the ammonium bisulfate absorption solution has a sulfuric acid concentration of 40% to 45% and an ammonium bisulfate concentration of 8% to 15%.

In some embodiments, the phosphate fertilizer includes one or more selected from the group consisting of ammonium phosphate, triple superphosphate, and calcium superphosphate; the nitrogen fertilizer includes one or more selected from the group consisting of ammonium sulfate, ammonium chloride, urea, and ammonium nitrate; and the potassium fertilizer includes one or more selected from the group consisting of potassium sulfate and potassium chloride.

In some embodiments, mixing the boron-magnesium-containing powder, the ammonium bisulfate absorption solution, and the first raw material is conducted by mixing the ammonium bisulfate absorption solution and the first raw material to obtain an acid-ammonia slurry, and mixing the acid-ammonia slurry and the boron-magnesium-containing powder to obtain the boron-magnesium-containing acid-ammonia slurry.

In some embodiments, the method further includes, after the granulation, the following steps: subjecting obtained fertilizer particles to first drying, first cooling, and first sieving sequentially to obtain first large particles, first normal particles, and first small particles; and crushing the first large particles and returning to the granulation, and directly returning the first small particles to the granulation;
subjecting the first normal particles to second drying, second cooling, and second sieving sequentially to obtain second large particles, second normal particles, and second small particles;
crushing the second large particles and returning to the granulation, and directly returning the second small particles to the granulation; and
subjecting the second normal particles to surface oil powder coating to obtain the boron-magnesium-containing compound fertilizer;
where the first large particles and the second large particles each have a particle size of greater than 4.0 mm; and the first small particles and the second small particles each have a particle size of less than 2.6 mm.

In some embodiments, the binder is bentonite.

In some embodiments, the boron-magnesium-containing compound fertilizer has an available magnesium content of greater than or equal to 1 wt % and an available boron content of greater than or equal to 0.02 wt %.

The present disclosure provides a method for producing a boron-magnesium-containing compound fertilizer, including the following steps: dissolving a boron mud in an ammonium sulfate solution to obtain a boron-magnesium-containing solution and ammonia gas; crystallizing the boron-magnesium-containing solution by baking to remove water to obtain a boron-magnesium-containing powder; and absorbing the ammonia gas with sulfuric acid to obtain an ammonium bisulfate absorption solution; mixing the boron-magnesium-containing powder, the ammonium bisulfate absorption solution, and a first raw material to obtain a boron-magnesium-containing acid-ammonia slurry; where the first raw material includes monoammonium phosphate and/or diammonium phosphate; and subjecting the boron-magnesium-containing acid-ammonia slurry, a second raw material, and a binder to granulation to obtain the boron-magnesium-containing compound fertilizer; where the second raw material includes one or more selected from the group consisting of a phosphate fertilizer, a nitrogen fertilizer, and a potassium fertilizer. In the present disclosure, the ammonium sulfate solution is added to dissolve the boron mud, and SiO₂, Fe₂O₃, Al₂O₃, and CaO in the boron mud can be chemically separated. Meanwhile, Mg₂B₂O₅·H₂O and MgO in the boron mud are dissolved to form an ammonium sulfate solution containing MgSO₄ and NH₄B(OH)₄, that is, the boron-magnesium-containing solution. Moreover, the (NH₄)₂SO₄, MgSO₄, and NH₄B(OH)₄ in the boron-magnesium-containing solution are at a content ratio of 20:111:8, which is basically consistent with a content ratio of medium and trace elements required in the relevant standards for compound fertilizer production. In the present disclosure, sulfuric acid is added to recover the ammonia gas generated during the dissolution of boron mud, and the ammonium bisulfate absorption solution obtained is used in subsequent production while achieving zero gas emissions.

In the present disclosure, the boron-magnesium-containing powder, ammonium bisulfate absorption solution, and the first raw material are used to prepare the boron-magnesium-containing acid-ammonia slurry. The acid-ammonia slurry has a high viscosity, which can improve the cohesiveness of the compound fertilizer during granulation, reduce the addition of binder, and increase a concentration of the available content of the compound fertilizer. Moreover, the use of acid-ammonia slurry can reduce the amount of water added in the traditional process, thereby reducing an energy load of the subsequent baking and improving a time efficiency of the production.

In the present disclosure, the boron-magnesium-containing acid-ammonia slurry, second raw material, and binder are subjected to granulation. During the granulation, in addition to adhesive bonding of the binder, the raw materials also have a fastening bonding effect of chemical bonds (NH₄⁺, Mg²⁺, SO₄²⁻, K⁺, Cl⁻, and NO₃⁻). In this way, the surface of formed compound fertilizer particles is smoother and rounder, reducing the adhesion between the compound fertilizer particles and the drum wall, and reducing dust of compound fertilizer during the granulation.

Further, a double drying and cooling process is conducted to process the granulated fertilizer particles. Specifically, the fertilizer particles obtained by granulation are subjected to the first drying, the first cooling, and the first sieving, and the normal particles obtained by the first sieving are subjected to the second drying, the second cooling, and the second sieving. The drying can not only remove part of the moisture in the fertilizer particles, but also has functions such as dust collection and secondary granulation. The drying temperature can increase the solubility of the fertilizer in the original water in the compound fertilizer particles. The change of liquid phase makes the compound fertilizer particles have a uniform liquid phase, desirable viscosity, and easier balling, thereby improving the balling quality. The cooling is not only to reduce the temperature of the compound fertilizer particles to a required level. After the fertilizer particles pass the first drying, there are many liquid droplets on the surface of the particles. These droplets can be condensed by cooling, and also have a function of third granulation. The lowered temperature reduces the solubility of the fertilizer in the original water in the compound fertilizer particles, causing the fertilizer to rapidly precipitate and aggregate. During the sieving, three types of particles are separated according to their particle size: large particles, normal particles, and small particles. The large particles are crushed and returned to the granulation; the small particles are directly returned to the granulation, and are re-agglomerated with the continuously added second raw material and boron-magnesium-containing acid-ammonia slurry to form compound fertilizer particles.

Further, the normal particles obtained by the second sieving are subjected to surface oil powder coating. During the surface oil powder coating, the surface of the compound fertilizer particles is evenly coated with an oil powder mixture, thereby preventing the compound fertilizer particles from absorbing moisture and hardening.

### BRIEF DESCRIPTION OF THE DRAWINGS

FIGURE shows a flow chart of the method for producing the boron-magnesium-containing compound fertilizer provided in an embodiment of the present disclosure.

### DETAILED DESCRIPTION OF THE EMBODIMENTS

The present disclosure provides a method for producing a boron-magnesium-containing compound fertilizer, including the following steps:
dissolving a boron mud in an ammonium sulfate solution to obtain a boron-magnesium-containing solution and ammonia gas; crystallizing the boron-magnesium-containing solution by baking to remove water to obtain a boron-magnesium-containing powder; and absorbing the ammonia gas with sulfuric acid to obtain an ammonium bisulfate absorption solution;
mixing the boron-magnesium-containing powder, the ammonium bisulfate absorption solution, and a first raw material to obtain a boron-magnesium-containing acid-ammonia slurry, where the first raw material includes monoammonium phosphate and/or diammonium phosphate; and
subjecting the boron-magnesium-containing acid-ammonia slurry, a second raw material, and a binder to granulation to obtain the boron-magnesium-containing compound fertilizer, where the second raw material includes one or more selected from the group consisting of a phosphate fertilizer, a nitrogen fertilizer, and a potassium fertilizer.

In the present disclosure, a flow chart of the method for producing the boron-magnesium-containing compound fertilizer is shown in FIGURE, which will be described in detail below in conjunction with FIGURE.

In the present disclosure, a boron mud is dissolved in an ammonium sulfate solution to obtain a boron-magnesium-containing solution and ammonia gas. In some embodiments, the boron mud is mainly composed of the following components: MgO, B₂O₃, SiO₂, Fe₂O₃, Al₂O₃, and CaO. The content of each component is shown in Table 1.

TABLE 1
Content of each component in the boron mud (mass fraction)

| Name of component | Unit | Content | Test basis |
|---|---|---|---|
| B₂O₃ | % | 3.5-4.5 | GB/T 30902-2014 |
| MgO | % | 31.0-34.0 | GB/T 14506.28-2010 |
| SiO₂ | % | 27.0-29.0 | GB/T 14506.28-2010 |
| Fe₂O₃ | % | 6.5-7.5 | GB/T 14506.28-2010 |
| Al₂O₃ | % | 4.0-5.0 | GB/T 14506.28-2010 |
| CaO | % | 2.0-3.0 | GB/T 14506.28-2010 |

In some embodiments of the present disclosure, the boron mud is dried before being dissolved; the drying is conducted by oven drying or natural air-drying; the drying is conducted at a temperature of 105° C. to 110° C.; and a dried boron mud is a solid powder with a fineness of 200 mesh.

In some embodiments of the present disclosure, the ammonium sulfate solution is a nearly saturated solution. In some embodiments, the ammonium sulfate solution is prepared with ammonium sulfate and water at a mass ratio of 60:100; a solubility of the ammonium sulfate increases with the increase of the temperature. The solubility is 71 g (NH₄)₂SO₄/100 g water at 20° C. and 103 g (NH₄)₂SO₄/100 g water at 100° C. In some embodiments, the ammonium sulfate solution is prepared at a ratio of 60 g (NH₄)₂SO₄/100 g water, which can completely avoid the precipitation and crystallization of (NH₄)₂SO₄ during storage and transportation while maintaining at a high concentration, thus promoting a dissolution rate of the boron mud.

In some embodiments of the present disclosure, the ammonium sulfate solution is used in an excess amount.

In some embodiments of the present disclosure, the dissolving is conducted at a temperature of 95° C. under a normal pressure; and a mass ratio of the boron mud to the ammonium sulfate solution is in a range of 1:(3-4), preferably 1:3.2.

In the present disclosure, if the boron mud is to be processed into a boron-magnesium-containing compound fertilizer, MgO and B₂O₃ in the boron mud need to be separated first. In this field, a commonly used chemical separation method is acid dissolution. In the acid dissolution, all strong acids such as sulfuric acid, hydrochloric acid, and nitric acid can dissolve multiple components in various boron muds at the same time, and thus simple and effective separation cannot be formed. Considering that magnesium and boron present in boron mud in the same form as in szaibelyite, part of MgO and B₂O₃ present in the form of Mg₂B₂O₅·H₂O (2MgO·B₂O₃·H₂O), and part of the same present in the form of MgO. In the present disclosure, the ammonium sulfate solution is used to dissolve boron mud. SiO₂, Fe₂O₃, and Al₂O₃ do not react with the (NH₄)₂SO₄ solution. The reactions of the Mg₂B₂O₅·H₂O, MgO, and CaO with the (NH₄)₂SO₄ solution are shown as follows:

CaO+(NH₄)₂SO₄═CaSO₄↓+2NH₃↑+H₂O

2(NH₄)₂SO₄+Mg₂B₂O₅·H₂O+2H₂O=2MgSO₄+2NH₄B(OH)₄+2NH₃↑

MgO+(NH₄)₂SO₄═MgSO₄+H₂O+2NH₃↑

It can be seen that after the dissolution of the (NH₄)₂SO₄ solution, in the boron mud, CaO generates CaSO₄ (precipitate), H₂O, and NH₃ (gas); Mg₂B₂O₅·H₂O generates 2MgSO₄ (dissolved), 2NH₄B(OH)₄ (dissolved), and NH₃ (gas); and MgO generates 2MgSO₄ (dissolved), H₂O, and NH₃ (gas). In some embodiments of the present disclosure, the obtained solution is filtered to obtain a solid as a waste impurity and a filtrate as the boron-magnesium-containing solution; the filtration is conducted at a temperature of 95° C.; ammonia gas generated during the dissolution is collected; a composition of the waste impurities is mainly SiO₂, and also contains a small amount of Fe₂O₃, a small amount of Al₂O₃, and a trace amount of CaSO₄; the boron-magnesium-containing solution mainly contains MgSO₄ and a small amount of NH₄B(OH)₄ and a trace amount of (NH₄)₂SO₄.

In the present disclosure, after obtaining the boron-magnesium-containing solution, the boron-magnesium-containing solution is crystallized by baking to remove water to obtain a boron-magnesium-containing powder. In some embodiments, the crystallization by baking to remove water is conducted at a temperature of 145° C. After the crystallization by baking to remove water is completed, the boron-magnesium-containing powder is obtained. In some embodiments, the boron-magnesium-containing powder contains magnesium with a mass fraction of 7.8% to 8.2%, preferably 8.0%, and boron with a mass fraction of 0.9% to 1.0%, preferably 0.9%. Specifically, in the boron-magnesium-containing powder, Mg presents in the form of MgSO₄, while B presents in the form of NH₄B(OH)₄. The boron-magnesium-containing powder contains MgSO₄ with a mass fraction of 36.3% to 37.7%, preferably 37.0%, and NH₄B(OH)₄ with a mass fraction of 2.7% to 2.9%, preferably 2.7%.

In the present disclosure, sulfuric acid is used to absorb the ammonia gas generated during the dissolution of the boron mud to obtain an ammonium bisulfate absorption solution. In some embodiments, the sulfuric acid has a concentration of 50 wt %; the absorption is conducted by an acid mist; when using sulfuric acid mist to absorb the ammonia gas, the lower the sulfuric acid concentration, the lower the absorption efficiency of the acid mist for the ammonia gas; conversely, the higher the sulfuric acid concentration, the higher the absorption efficiency of the acid mist for the ammonia gas. However, when the concentration of sulfuric acid is excessive, there are strong oxidizing properties to generate sulfur dioxide when absorbing ammonia gas. Therefore, it is impossible to completely eliminate gas generated during the production and achieve zero emissions. By controlling the sulfuric acid concentration to 50 wt %, no sulfur dioxide is produced during ammonia gas absorption, and there is a high absorption efficiency. In some embodiments, the acid mist absorption is conducted in a fiber reinforced plastics (FRP) anti-corrosion and anti-aging acid mist ammonia gas absorption tower, which is purchased from Hebei Hengwei FRP Co., Ltd.

In some embodiments of the present disclosure, the sulfuric acid is used in an excess amount; and a reaction formula of the sulfuric acid and ammonia gas is as follows:

2NH₃+H₂SO₄═(NH₄)₂HSO₄

In some embodiments of the present disclosure, the components of the ammonium bisulfate absorption solution include ammonium bisulfate and sulfuric acid, where the concentration of ammonium bisulfate is in a range of 8 wt % to 15 wt %, and the concentration of sulfuric acid is in a range of 40 wt % to 45 wt %.

In the present disclosure, after obtaining the boron-magnesium-containing powder and the ammonium bisulfate absorption solution, the boron-magnesium-containing powder, the ammonium bisulfate absorption solution, and a first raw material are mixed to obtain a boron-magnesium-containing acid-ammonia slurry. In the present disclosure, the first raw material includes monoammonium phosphate and/or diammonium phosphate. In some embodiments, mixing the boron-magnesium-containing powder, the ammonium bisulfate absorption solution, and the first raw material specifically is conducted by: mixing the ammonium bisulfate absorption solution and the first raw material to obtain an acid-ammonia slurry, and mixing the acid-ammonia slurry and the boron-magnesium-containing powder to obtain the boron-magnesium-containing acid-ammonia slurry. In some embodiments, the ammonium bisulfate absorption solution and the first raw material are added to an ammonia-acid production device to allow mixing to form an acid-ammonia slurry; in some embodiments, the ammonia-acidification production device is the one published in the utility model patent No. ZL202222402891.6. There are no special requirements for a ratio of the boron-magnesium-containing powder, ammonium bicarbonate solution, and the first raw material, which can be adjusted according to actual needs according to the content of each element in the target compound fertilizer.

In the present disclosure, after obtaining the boron-magnesium-containing acid-ammonia slurry, the boron-magnesium-containing acid-ammonia slurry, a second raw material, and a binder are subjected to granulation to obtain the boron-magnesium-containing compound fertilizer. In some embodiments, the second raw material includes one or more selected from the group consisting of a phosphate fertilizer, a nitrogen fertilizer, and a potassium fertilizer; the phosphate fertilizer includes one or more selected from the group consisting of ammonium phosphate, triple superphosphate, and calcium superphosphate; the nitrogen fertilizer includes one or more selected from the group consisting of ammonium sulfate, ammonium chloride, urea, and ammonium nitrate; and the potassium fertilizer includes one or more selected from the group consisting of potassium sulfate and potassium chloride. The second raw material is a powder. The specific types of the first raw material and the second raw material are added according to actual needs according to the types of elements in the target compound fertilizer. There are no special requirements for a ratio of the boron-magnesium-containing acid-ammonia slurry and the second raw material, which can be adjusted according to actual needs according to the content of each element in the target compound fertilizer. In some embodiments, the binder is bentonite; and the bentonite is added in an amount of 5% to 6%, based on a mass of the boron-ammonium-containing acid-ammonia slurry.

In some embodiments of the present disclosure, the granulation is conducted in a drum granulator; the boron-magnesium-containing acid-ammonia slurry is metered into the drum granulator in a liquid form, and then agglomerated with the second raw material into fertilizer particles through three actions of “rolling, squeezing, and friction” in the drum granulator.

In the present disclosure, after obtaining the fertilizer particles, the obtained fertilizer particles are subjected to first drying, first cooling, and first sieving sequentially to obtain first large particles, first normal particles, and first small particles; and the first large particles are crushed and then returned to the granulation, and the first small particles are directly returned to the granulation; the first normal particles are subjected to second drying, second cooling, and second sieving sequentially to obtain second large particles, second normal particles, and second small particles; and the second large particles are crushed and then returned to the granulation, and the second small particles are directly returned to the granulation; and the second normal particles are subjected to surface oil powder coating to obtain the boron-magnesium-containing compound fertilizer. In some embodiments, the first large particles and the second large particles each have a particle size of greater than 4.0 mm; the first small particles and the second small particles each have a particle size of less than 2.6 mm; in some embodiments, the first normal particles and the second normal particles each have a particle size of 2.6 mm to 4.0 mm. In some embodiments, the first drying is oven drying, and the drying is conducted in a drying oven. In some embodiments, a heating medium in the drying oven is hot air, and the hot air has a temperature of 120° C. The drying can not only remove part of the moisture in the fertilizer particles, but also has functions such as dust collection and secondary granulation. The increased temperature can increase the solubility of fertilizers in the original water in the compound fertilizer particles. The change of liquid phase makes the compound fertilizer particles have a uniform liquid phase, desirable viscosity, and easier balling, which can improve a balling quality.

In some embodiments of the present disclosure, the first cooling is conducted by cooling to ambient temperature, and the first cooling is natural cooling. The cooling is not only to reduce the temperature of the compound fertilizer particles to a required level. After the fertilizer particles pass the first drying, there are many liquid droplets on the surface of the particles. These droplets can be condensed by the cooling, and also have a function of third granulation. The lowered temperature reduces the solubility of the fertilizer in the original water in the compound fertilizer particles, causing the fertilizer to rapidly precipitate and aggregate.

In some embodiments of the present disclosure, the first sieving is conducted using a sieving machine; the first large particles are preferably crushed using a crusher.

In some embodiments of the present disclosure, the method and conditions of the second drying are the same as those of the first drying, and will not be repeated here. The second drying can quickly evaporate the liquid droplets condensed on the surface of the fertilizer particles during the first cooling, and the other effects are the same as those of the first drying.

In the present disclosure, the temperature of the second cooling is the same as that of the first cooling, which will not be repeated here. During the second cooling, except that liquid droplets are no longer condensed on the surface of the fertilizer particles, the other effects are the same as those in the second cooling.

In the present disclosure, a process of the second sieving is the same as that of the first sieving, and will not be repeated here; the second sieving removes particles that are too large due to bonding during the second drying, and particles that crack and become smaller during the second cooling.

In some embodiments of the present disclosure, the surface oil powder coating is conducted by mixing the second normal particles with an oil powder mixture, where the oil powder mixture is a mixture of oil and powder. In some embodiments, the oil is one or more selected from the group consisting of palm oil, stearic acid, paraffin, and stearylamine; and the powder is one or more selected from the group consisting of talc, bentonite, and diatomaceous earth. In a specific example, the oil powder mixture is a mixture of palm oil and talc; a mass of the oil is two thousandths of that of the second normal particles; and a mass of the powder is four thousandths of that of the second normal particles. The surface oil powder coating causes the surface of the fertilizer particles to be evenly coated with the oil powder mixture, which can prevent moisture absorption and hardening of the fertilizer particles.

In some embodiments of the present disclosure, after the surface oil powder coating is completed, the boron-magnesium-containing compound fertilizer is subjected to metered packaging; and the metered packaging includes bagging, load-bearing, sewing sealing, and inkjet coding.

In some embodiments of the present disclosure, the boron-magnesium-containing compound fertilizer has an available magnesium content of greater than or equal to 1 wt % and an available boron content of greater than or equal to 0.02 wt %. In some embodiments, the boron-magnesium-containing compound fertilizer meets the index requirements in the China standard GB/T 15063-2020 “Compound Fertilizer”.

The technical solutions of the present disclosure will be clearly and completely described below in conjunction with specific examples of the present disclosure. Obviously, the described examples are only a part of, not all of, the examples of the present disclosure. All other embodiments obtained by those skilled in the art based on the embodiments of the present disclosure without creative efforts shall fall within the scope of the present disclosure.

### Example 1

An ammonium sulfate solution was prepared according to a ratio of 60 g (NH₄)₂SO₄/100 g water. A boron mud was dissolved in the ammonium sulfate solution at 95° C., where a mass ratio of the boron mud to the ammonium sulfate solution was 1:3.2. An obtained feed liquid was filtered to obtain a waste impurity and a boron-magnesium-containing solution. An FRP anti-corrosion and anti-aging acid mist ammonia absorption tower from Hebei Hengwei FRP Co., Ltd. (China) was used to absorb ammonia gas generated during the dissolution using sulfuric acid with a concentration of 50 wt %, so as to obtain an ammonium bisulfate absorption solution (with an ammonium bisulfate concentration of 8%, and a sulfuric acid concentration of 41%).

The boron-magnesium-containing solution was baked to remove water by gradually heating to 145° C. for crystallization to obtain a boron-magnesium-containing powder, in which the content of MgSO₄ was 37% and the content of NH₄B(OH)₄ was 2.7%.

The ammonium bisulfate absorption solution, monoammonium phosphate, and diammonium phosphate (the amounts of each raw material are shown in Table 2) were added into an ammonia-acidification production device (utility model patent: ammonia-acidification production device of compound fertilizer, patent number: ZL 202222402891.6, Patentee: Liaoning Tianhe Agricultural Science and Technology Co., Ltd.) and mixed to obtain an acid-ammonia slurry. The acid-ammonia slurry was mixed with the boron-magnesium-containing powder to obtain a boron-magnesium-containing acid-ammonia slurry.

The boron-magnesium-containing acid-ammonia slurry was metered into a drum granulator in a liquid form, while urea, ammonium chloride, potassium chloride, ammonium carbonate, and bentonite (the amounts of each raw material are shown in Table 2) were added into the drum granulator, and agglomerated into fertilizer particles through three actions: “rolling, squeezing, and friction”.

The fertilizer particles were dried in a drying oven with hot air at 120° C., then naturally cooled to ambient temperature, and then sieved through a sieving machine to obtain large particles (with a particle size of greater than 4.0 mm), normal particles (with a particle size of 2.6 mm to 4.0 mm), and small particles (with a particle size of less than 2.6 mm). The large particles were sent to a crusher and transferred to the drum granulator after crushing, while small particles were sent directly to the drum granulator. The normal particles were added into the drying oven and dried for the second time under hot air at 120° C. Then, natural cooling and sieving were conducted again to obtain large particles (with a particle size of greater than 4.0 mm), normal particles (with a particle size of 2.6 mm to 4.0 mm), and small particles (with a particle size of less than 2.6 mm). The large particles were sent to the crusher and transferred to the drum granulator after crushing, while the small particles were directly added to the drum granulator. The normal particles were subjected to surface oil powder coating with an oil powder mixture being a mixture of palm oil and talc, such that a surface of the fertilizer particle was evenly coated with the oil powder mixture, obtaining a boron-magnesium-containing compound fertilizer. The compound fertilizer particles after surface oil powder coating were measured and packaged through bagging, load-bearing, sewing sealing, and inkjet coding.

TABLE 2
Amounts of raw materials

| | Mass index | | | | | | | |
|---|---|---|---|---|---|---|---|---|
| Raw material | | | | | Moisture | Total | | Added position |
| Name | N | P₂O₅ | K₂O | Cl | content | NPK | kg | / |
| Boron-magnesium- | / | / | / | / | / | / | 185 | Adding to |
| containing powder | | | | | | | | acid-ammonia slurry |
| | | | | | | | | to generate |
| | | | | | | | | boron-magnesium- |
| | | | | | | | | containing |
| | | | | | | | | acid-ammonia slurry |
| Ammonium bisulfate | / | / | / | / | / | / | 20 | Adding to |
| absorption solution | | | | | | | | ammonia-acidification |
| | | | | | | | | production device |
| Diammonium | 15.0% | 42.0% | 0.0% | 0.0% | 0.0% | 57.0% | 50.00 | Adding to |
| phosphate | | | | | | | | ammonia-acidification |
| | | | | | | | | production device |
| Monoammonium | 11.0% | 44.0% | 0.0% | / | 2.0% | 55.0% | 185.00 | Adding to |
| phosphate | | | | | | | | ammonia-acidification |
| | | | | | | | | production device |
| Urea | 46.0% | 0.0% | 0.0% | / | 0.6% | 46.0% | 483.00 | Adding to drum |
| | | | | | | | | granulator |
| Ammonium chloride | 25.0% | 0.0% | 0.0% | 67.7% | 2.0% | 25.0% | 27.00 | Adding to drum |
| (dry) | | | | | | | | granulator |
| Potassium chloride | 0.0% | 0.0% | 60.0% | 47.7% | 1.0% | 60.0% | 205.00 | Adding to drum |
| | | | | | | | | granulator |
| Ammonium carbonate | 17.0% | / | / | / | / | / | 50.00 | Adding to drum |
| | | | | | | | | granulator |
| Bentonite | / | / | / | / | / | / | 50.0 | Adding to drum |
| | | | | | | | | granulator |
| Anti-caking oil | / | / | / | / | / | / | 7.00 | Adding during |
| powder | | | | | | | | surface oil powder |
| | | | | | | | | coating |
| Total | | | | | | | 1262.0 | / |

The boron-magnesium-containing compound fertilizer was tested according to the Chinese national standard GB/T 15063-2020 “Compound Fertilizer”, and the results are shown in Table 3.

TABLE 3
Test results of boron-magnesium-containing compound
fertilizer with total nutrients ≥ 48, 26-10-12

| | | Standard requirement and | | |
|---|---|---|---|---|
| | | marked amount | Inspection | Single |
| No. | Test items | requirement | result | conclusion |
| 1 | Total nutrients | ≥48.0 | 48.66 | Qualified |
| | (N + P₂O₅ + K₂O), % | | | |
| 2 | Total nitrogen (N), % | ≥24.5 | 26.33 | Qualified |
| 3 | Available phosphorus | ≥8.5 | 10.31 | Qualified |
| | pentoxide (P₂O₅), % | | | |
| 4 | Potassium oxide (K₂O), % | ≥10.5 | 12.02 | Qualified |
| 5 | Percentage of water-soluble | ≥60 | 60 | Qualified |
| | phosphorus in available | | | |
| | phosphorus, % | | | |
| 6 | Particle size (1.00 mm-4.75 | ≥90 | 95 | Qualified |
| | mm), % | | | |
| 7 | Chloride ions, % | ≤15.0 | 14.5 | Qualified |
| 8 | Biuret, % | ≤1.5 | 0.6 | Qualified |
| 9 | Available magnesium (based | ≥1.0 | 1.13 | Qualified |
| | on elemental substance), % | | | |
| 10 | Available boron (based on | ≥0.02 | 0.13 | Qualified |
| | elemental substance), % | | | |

According to the data in Table 3, the present disclosure could prepare a boron-magnesium-containing compound fertilizer that meets Chinese national standards by using boron mud as a raw material.

The above descriptions are merely preferred embodiments of the present disclosure. It should be noted that a person of ordinary skill in the art may further make several improvements and modifications without departing from the principle of the present disclosure, but such improvements and modifications should be deemed as falling within the scope of the present disclosure.

What is claimed is:

1. A method for producing a boron-magnesium-containing compound fertilizer, comprising
dissolving a boron mud in an ammonium sulfate solution to obtain a boron-magnesium-containing solution and ammonia gas; crystallizing the boron-magnesium-containing solution by baking to remove water to obtain a boron-magnesium-containing powder; and absorbing the ammonia gas with sulfuric acid to obtain an ammonium bisulfate absorption solution;
mixing the boron-magnesium-containing powder, the ammonium bisulfate absorption solution, and a first raw material to obtain a boron-magnesium-containing acid-ammonia slurry, wherein the first raw material comprises monoammonium phosphate and/or diammonium phosphate; and
subjecting the boron-magnesium-containing acid-ammonia slurry, a second raw material, and a binder to granulation to obtain the boron-magnesium-containing compound fertilizer, wherein the second raw material comprises one or more selected from the group consisting of a phosphate fertilizer, a nitrogen fertilizer, and a potassium fertilizer.

2. The method of claim 1, further comprising, after the dissolving, filtering a dissolved solution obtained from the dissolving to obtain a solid as an impurity and a filtrate as the boron-magnesium-containing solution.

3. The method of claim 1, wherein the boron-magnesium-containing powder contains magnesium with a mass fraction of 7.8% to 8.2% and boron with a mass fraction of 0.9% to 1.0%.

4. The method of claim 1, wherein the sulfuric acid has a concentration of 50 wt %; and the absorbing is conducted with an acid mist.

5. The method of claim 1, wherein the ammonium bisulfate absorption solution has a sulfuric acid concentration of 40% to 45% and an ammonium bisulfate concentration of 8% to 15%.

6. The method of claim 1, wherein the phosphate fertilizer comprises one or more selected from the group consisting of ammonium phosphate, triple superphosphate, and calcium superphosphate;
the nitrogen fertilizer comprises one or more selected from the group consisting of ammonium sulfate, ammonium chloride, urea, and ammonium nitrate; and
the potassium fertilizer comprises one or more selected from the group consisting of potassium sulfate and potassium chloride.

7. The method of claim 1, wherein mixing the boron-magnesium-containing powder, the ammonium bisulfate absorption solution, and the first raw material is conducted by mixing the ammonium bisulfate absorption solution and the first raw material to obtain an acid-ammonia slurry, and mixing the acid-ammonia slurry and the boron-magnesium-containing powder to obtain the boron-magnesium-containing acid-ammonia slurry.

8. The method of claim 1, further comprising, after the granulation, the following steps:
subjecting obtained fertilizer particles to first drying, first cooling, and first sieving sequentially to obtain first large particles, first normal particles, and first small particles; and crushing the first large particles and then returning to the granulation, and directly returning the first small particles to the granulation;
subjecting the first normal particles to second drying, second cooling, and second sieving sequentially to obtain second large particles, second normal particles, and second small particles; and crushing the second large particles and then returning to the granulation, and directly returning the second small particle to the granulation; and
subjecting the second normal particles to surface oil powder coating to obtain the boron-magnesium-containing compound fertilizer,
wherein the first large particles and the second large particles each have a particle size of greater than 4.0 mm; and the first small particles and the second small particles each have a particle size of less than 2.6 mm.

9. The method of claim 1, wherein the binder is bentonite.

10. The method of claim 1, wherein the boron-magnesium-containing compound fertilizer has an available magnesium content of greater than or equal to 1 wt % and an available boron content of greater than or equal to 0.02 wt %.

11. The method of claim 4, wherein the ammonium bisulfate absorption solution has a sulfuric acid concentration of 40% to 45% and an ammonium bisulfate concentration of 8% to 15%.
